(19) United States
(12) Patent Application Publication
(10) Pub. No.: US 2003/0110277 A1
(43) Pub. Date: Jun. 12, 2003

(54) Method and platform for using wireless multimedia files

(76) Inventors: Sheng-Tzong Cheng, Tainan (TW); Ting-Ching Hsu, Taichung (TW); Kuan-Hung Lu, Tainan (TW); Chun-Hung Chen, Tainan Hsien (TW)

Correspondence Address: Beehler & Pavitt, Suite 330, 100 Corporate Pointe, Culver City, CA, 90230, US

(21) Appl. No.: 10/014,998

(22) Filed: Dec. 10, 2001

(51) Int. Cl. G06F 15/16

(52) U.S. Cl. 709/231; 709/247

(57) ABSTRACT

The objective of the present invention is able to provide a transferring method whereby a multimedia file on the web is able to transmit a multimedia format adapted for a hand-held device. Especially, the platform with the method is able to detect connecting state between the hand-held device and the platform and send a suitable multimedia file to the hand-held device.

### BACKGROUND OF THE INVENTION

1. Field of the Invention

The present invention relates to a method for using wireless multimedia files and more particularly to a method that is adapted to allow a multimedia file including digital compressed video and voice components to be played on a hand-held device with low frequency bandwidth.

2. Description of Related Art

As electronic commerce has developed on the web, each of the web sites are designed in ASP (active service page) format to attract more customers. The ASP includes considerable images, video, and voice etc. files designed as a multimedia page. Transmitting the web page, such as the multimedia pages, to the client needs enough bandwidth. But it is difficult to transmit the multimedia pages to the client via the wireless web.

Lastly, a SMIL (synchronized multimedia integration language) is developed to design the multimedia pages easily. Therefore, there are many media computers, as RealNetworks™ and QuickTime™, trying to develop multimedia browsers to support the SMIL format. The multimedia browsers, such as Fluition™ by Confluent Technologies™, Grins™ by Oratrix™, MAGpie™, captioning tool by WGBH™, Real Slideshow 2.0™ by RealNetworks™ and SMIL Composer SuperToolz™ by HotSausage™ are provided for user downloading. With reference to FIG. 7, a program file of the SWIL is shown, wherein the program includes two video files (003.mpeg and 001.mpeg) and one picture (002.jpg). Referring to FIG. 8, a browser (50) executes the SMIL program, and shows two video (60)(61) corresponded to the two video files of the program and one picture (62) corresponded to the one picture of the program at the same time. Therefore, the web sites are designed toward multimedia files to demonstrate products and services on the web.

Recently, the mobile hand-held device is popular and not only enables transmitting voice information, but also provides data information to each other. The WAP (wireless active page) is developed to transfer the HTML page to XML (eXtensible Markup Language) page, that is, the HTML (Hypertext Markup Language) page is able to be shown on a monitor of the mobile hand-held device via WAP. The HTML pages involve fewer data bits than the multimedia page, but WAP does not have enough transmitting bandwidth to transmit the multimedia format. That is, the monitor of the mobile hand-held device does not browse the multimedia pages from the web, or even connect to the Internet via wireless net.

The present invention provides a transferring method and platform to make the wireless hand-held device be able to browse the multimedia on the web.

### SUMMARY OF THE INVENTION

The objective of the present invention is to provide a transferring method wherein the multimedia page of web is able to transmit a multimedia format adapted for a hand-held device.

Other objects, advantages, and novel features of the invention will become more apparent from the following detailed description when taken in conjunction with the accompanying drawings.

### BRIEF DESCRIPTION OF THE DRAWINGS

FIG. 1 is a structure of the WSMIL (wireless synchronized multimedia integration language) in accordance with the present invention;

FIGS. 2A-2G are program examples according to the WSMIL of the FIG. 1;

FIG. 3 is a block diagram of a transmitting platform in accordance with the present invention;

FIG. 4 is an active flow of the transmitting platform and the hand-held device in accordance with the present invention;

FIG. 5 is a program example of an embodiment of the WSMIL file in accordance with the present invention;

FIG. 6 is a frame of the FIG. 5 shown on a browser of a hand-held device;

FIG. 7 is a program of a SMIL multimedia file; and

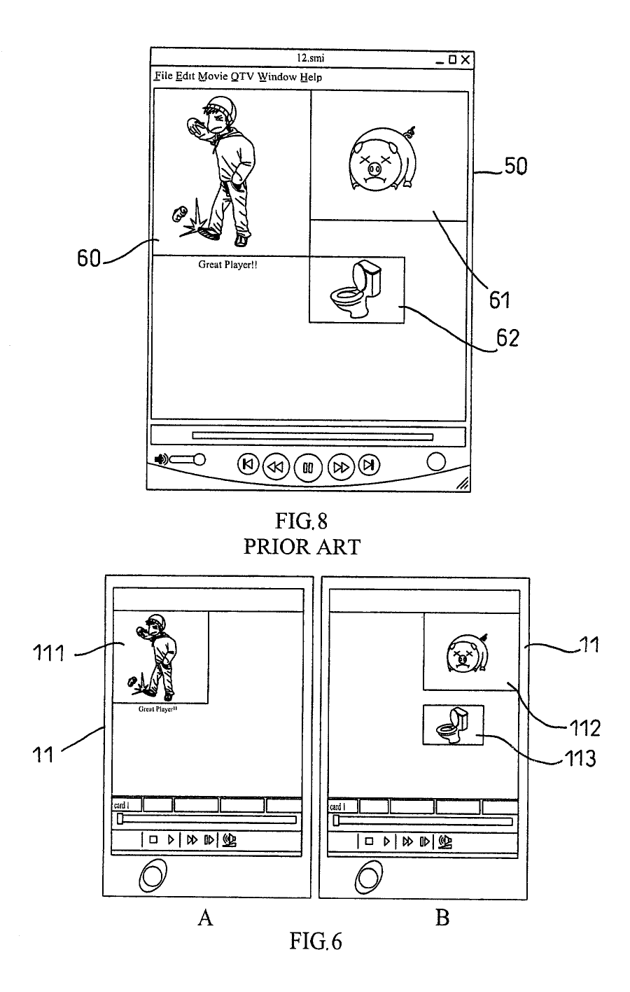

FIG. 8 is a frame of the FIG. 7 shown on a browser of a common electronic device such as PC browser.

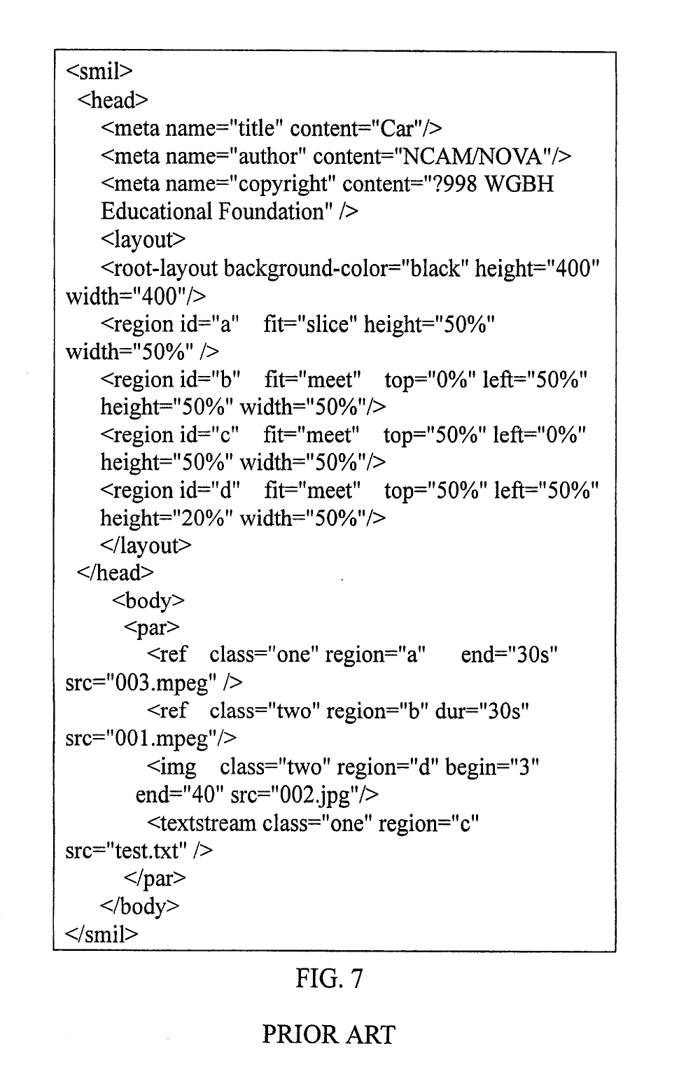

### DETAILED DESCRIPTION OF THE PREFERRED EMBODIMENT

A WSMIL (wireless synchronized multimedia integration language) develops to base on an XML (eXtensible Markup Language), especially using the WSMIL to design multimedia files is able to be adapted for a hand-held device browsing a multimedia file from the World Wide Web. A standard of the WSMIL allows playing of one multimedia file with a compressed video and a compressed voice components when the hand-held device send a browsing request to web site of the World Wide Web Wherein the WSMIL multimedia file uses card elements to separate multimedia files to one multimedia file, and then uses class elements to classify related multimedia files. Therefore, the WSMIL is able to show one multimedia file on a browser of the hand-held device send a browsing request to the web site designed by WSMIL.

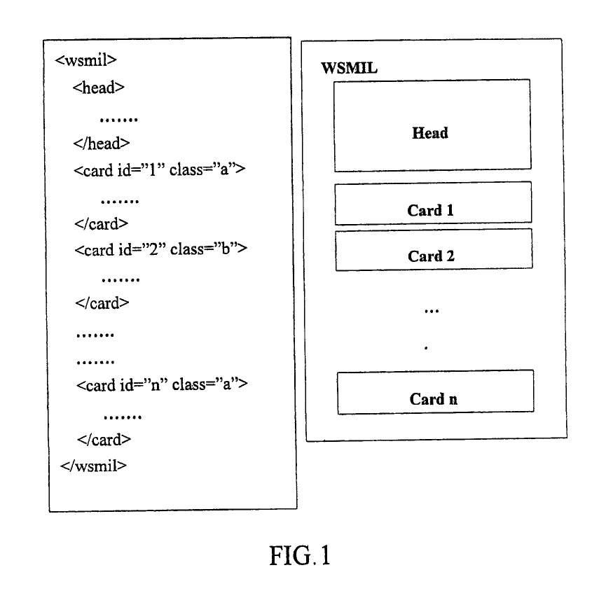

With reference to FIG. 1, a structure of the WSMIL is shown. Components of the WSMIL multimedia file are at least one head element and at least one card element. An attribute of each card element defined by an id (identifying number). The head element includes multimedia information, such as the author and production date of the WSMIL multimedia file, and the class element is used for classifying the card elements related each other. Besides, the card element includes information with a timing order and linking space of the multimedia file for deciding the play multimedia sequence on the browser.

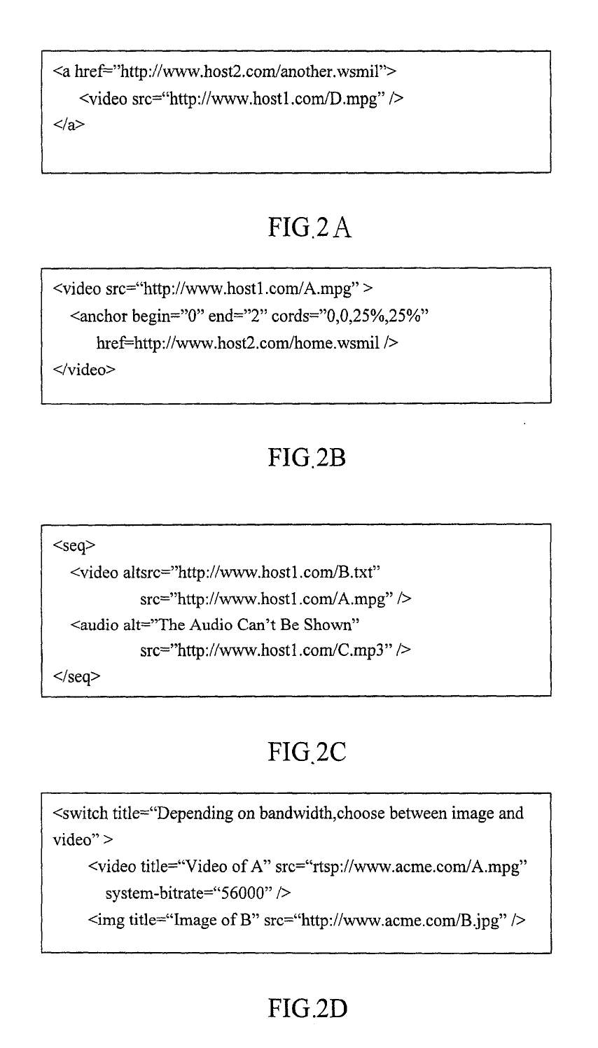

With reference to FIGS. 2A and 2B, hyper linking examples of the WSMIL file are shown. A URL (Uniform Resource Locator) address, www.host2.com/anther.wsmil, is combined on a D image for providing a user to click, and then connects to the URL address. A size of an A image with the URL address is able to adjust by using an anchor element and a cord element, as shown in FIG. 2B. Besides, a linking time from the A image clicked is able to be preset by using a begin element and an end element. As shown in FIG. 2B, when the A image is clicked, the hyper linking is begun to execute after two minutes.

Referencing to the FIG. 2C, the WSMIL multimedia file further comprises substituting elements to replace some of the multimedia pages with video and voice files to show on the browser of the hand-held device by the image or test format. The substituting elements are an alt element and an altsrc element. An example is shown in FIG. 2C, when a digital video file, A.mpg, does not show on the browser, and then a B.txt replaces the A.mpg to show on the browser. If the voice file, C.mp3, does not show, a text “The Audio Can Not Be Shown” replaces the voice file to show.

With reference to FIG. 2D, an example of the WSMIL file with system parameters is shown. The system parameters are designed for detecting a connecting rate of a client device. Therefore, the multimedia file is designed for a different showing frame, as shown FIG. 2D, when the connecting rate between a Web site with a URL address and the client device is over 56000 bits/sec, and then A.mpg is shown on the browser of the client device. If the connecting rate is less than 56000 bits/sec, a frame of a B.jpg is shown on the browser. Using the system parameter elements provides a content adaptation service according to different client devices.

With reference to FIGS. 2E and 2F, examples of multimedia files using layout elements to design position of multimedia components are shown on the browser. The layout elements are region element, % parameter, pixel etc. parameters.

With reference to FIG. 2G, an example of the WSMIL multimedia files is playing order. Because WSMIL is able to allow one multimedia file to show each required send, a video A/an audio A and a video B/an audio B are shown at different times.

As per the above description, a WSMIL multimedia file is able to detect the client device and decides how much load of the related information is downloaded to the browser. Especially, the WSMIL multimedia file always allows one video file and one voice file to show, thus the multimedia file is able to be easily demonstrated on the browser of a hand-held device.

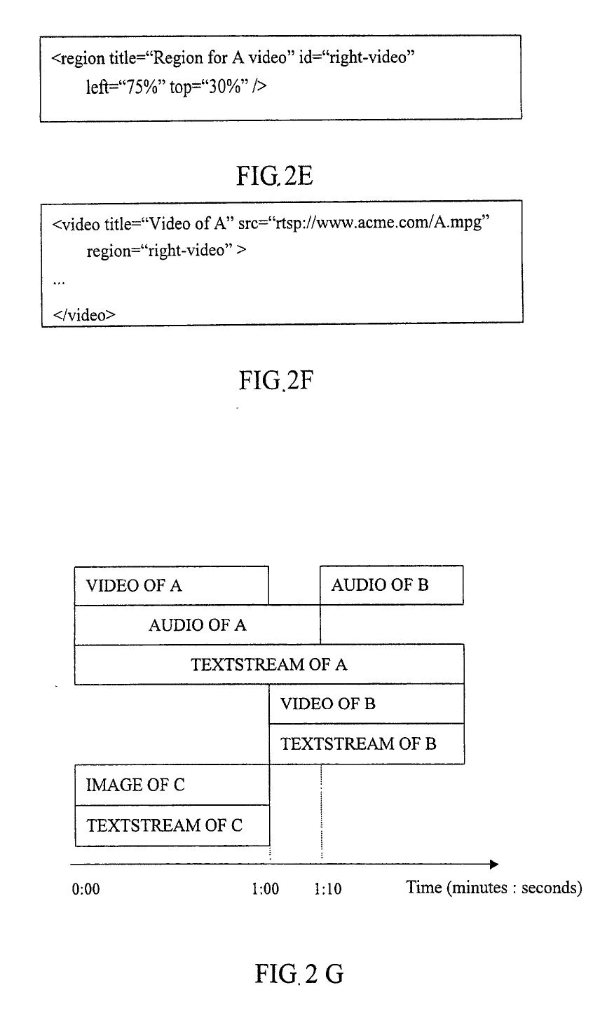

Referencing to FIG. 3, a structure of a transferring platform for transmitting an SMIL multimedia file to a WSMIL multimedia file applied on the mobile client. A WEB structure comprises a client device (10), a WAP gateway (20) offering the hand-held device a way to connect to the Web, and a Web server (30) connected to the WAP gateway (20). The platform (40) connects a web server (30) with the client device (10), wherein SMIL Documents and multimedia resources according to the SMIL files are connected to the platform (40). The client device (10), i.e. the hand-held device, uses a PCMCIA to connect an IEEE802.11 wireless web card that is able to have dual connection with the WAP gateway (20).

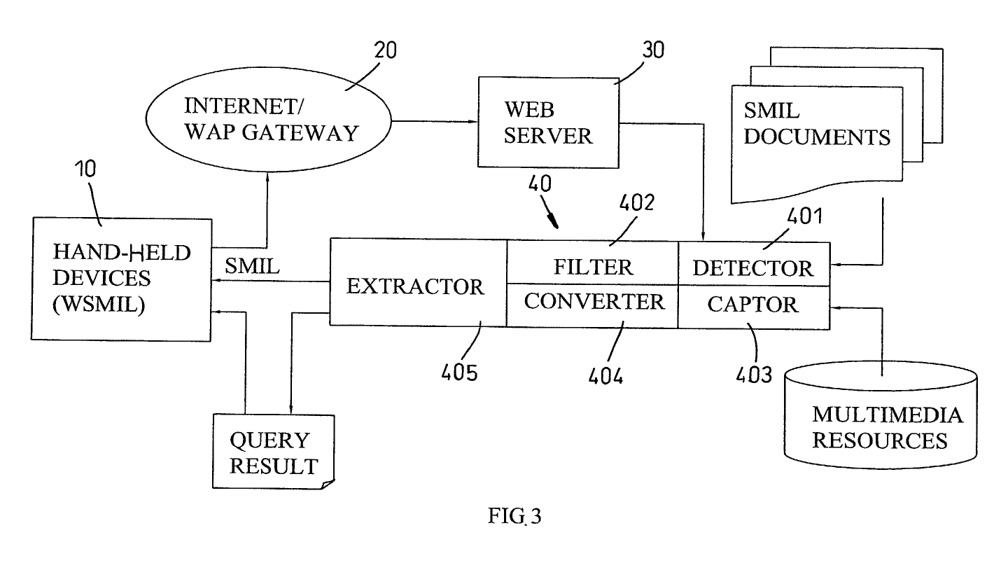

The platform (40) comprises a detector (401), a filter (402), a captor (403), a converter (404), and an extractor (405). The detector (401) detects the states of the client device (10) and then decides if the SMIL file should be transmitted. The filter (402) connected the SMIL documents with the detector (401) transfers the SMIL files to WSMIL file. Because the WSMIL bases on the XML, the filter is an XML parser. The captor (403) connected to the multimedia resource with a plurality of multimedia components catches multimedia elements that the WSMIL needs, and stores them. The converter (404) catches the multimedia elements from the captor (403) and converts the multimedia elements to low data bits format, that is, a video file converts to a digital compressed file and a voice file converts to a digital compressed file. The extractor (405) connected to the filter (402) and the converter (404) transmits the WSMIL file and the low data bits of the digital compressed multimedia elements to the client device send browsing require to the web site offering SMIL multimedia files. Referencing to FIGS. 3 and 4, an operating flow of the platform is shown when the client device (10) sends a browsing request to the platform (40). Firstly, the detector (401) detects states of the client device (10) such as the transmitting rate in the connection with the platform (40). If the transmitting rate is able to allow to download big data bits of the SWIL multimedia files, the platform (40) does not convert the SWIL files to the WSMIL file, and directly sends the SWIL files to the client device (10). But if the transmitting rate is not able to browse the SMIL multimedia files then the detector (401) catches the SMIL files and sends them to the filter (402), such as an XML PARSER. The filter (402) extracts an SMIL DOM tree from the SMIL file and then transfers the SMIL DOM tree to a WSMIL DOM tree. Secondly, the captor (403) catches the multimedia components according to URL addresses from the multimedia resource. Then the converter (404) converts the multimedia components to a digital compressed format such as mepg and mp3 formats for sending the multimedia components through the extractor (405) to the client device (10), especially, the hand-held device. Therefore, the platform is able to transfer the SMIL file to the WSMIL file browsed on the hand-held device.

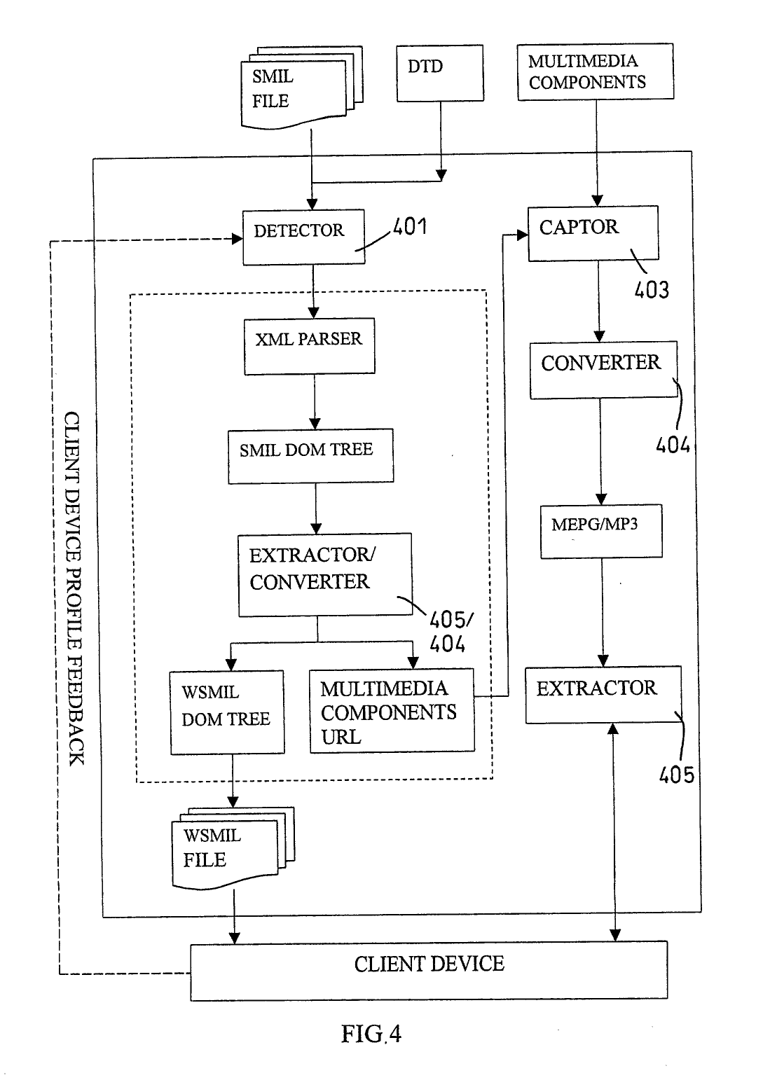

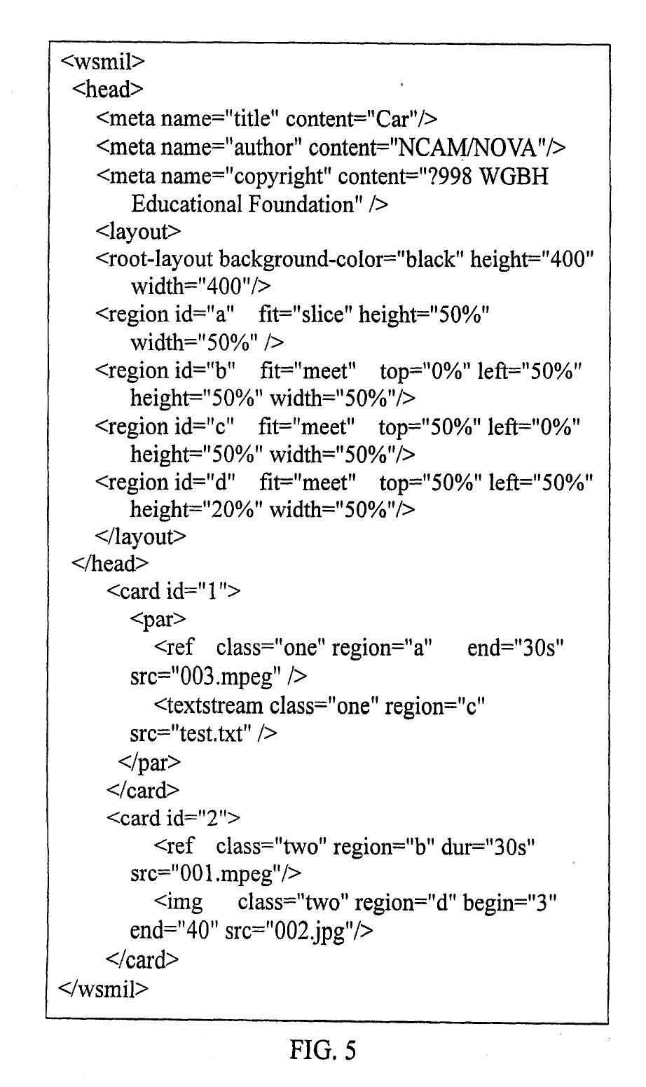

With reference to FIG. 5, a program of the WSMIL file corresponds to the frame shown in FIGS. 6A and 6B. Firstly, the WSMIL file includes a first video file (003.mpeg) and a second file (001.mpeg), and one picture file (002.jpg), wherein a first card element describes the first video file, and a second card element describes the second video file and the picture file. When the client downloads this WSMIL file and the multimedia components to a browser (11) of the hand-held device (not shown), the browser (11) executes the program and then show one video (111), as shown in FIG. 6A. When the first video (111) has finished playing, the browser (11) follows the card element order, that is the second card element, to show the second video (112) and the picture (113), as shown in FIG. 6B. The one video file has fewer data bits than at lest two video files, so as to allow the WSMIL multimedia file to be downloaded quickly.

Although the present invention has been explained in relation to its preferred embodiment, it is to be understood that many other possible modifications and variations can be made without departing from the spirit and scope of the invention as hereinafter claimed.

What is claimed is:

1. A method for playing wireless multimedia files, comprising:
adding at least one card element having a compressed video file and a compressed voice file in a multimedia file for containing a multimedia component; and
adding at least one class element in the multimedia file to classify the card elements related each other to a multimedia file; wherein one multimedia file shown according to the card elements.

2. The method as claimed in claim 1, wherein the multimedia file further comprising system parameters detect the connecting state of a client device to offered a suitable multimedia components to the client device.

3. The method as claimed in claim 1, wherein further comprising hyper linking parameters having an anchor element and a cord element to design a size of a linking picture of the multimedia file.

4. The method as claimed in claim 3, wherein a begin element and an end element are used with the anchor element to set a hyper linking time.

5. The method as claimed in claim 1, wherein further comprising substituting elements (alt/altsrc) to set low data bits multimedia components to replace the high data bits multimedia component.

6. The method as claimed in claim 1, wherein further comprising space layout elements (region) to define positions and size of the multimedia components shown on the browser.

7. The method as claimed in claim 6, wherein the region element further comprises % parameter and pixel parameters to set the size of the multimedia components.

8. A platform for playing wireless multimedia files comprising
a detector detecting a connecting state between a client device and the platform and connected to an SMIL document having SMIL files;
a filter connected to the detector to transfer one of the SMIL files extracted from the SMIL document by the detector to a WSMIL file;
a captor connected to a multimedia resource having a plurality of multimedia components adapted to the SMIL files;
a converter connected to the captor to convert the multimedia components to digital compressed format; and
an extractor connected to the filter with the converter to transmit the WSMIL file and the digital compressed multimedia components to the client device.

9. The platform as claimed in claim 8, wherein the filter is an XML Parser.
